(19) United States
(12) Patent Application Publication
(10) Pub. No.: US 2005/0182836 A1
(43) Pub. Date: Aug. 18, 2005

(54) Method for transparently auditing employee and contractor FTP usage

(76) Inventor: Teddy C. Johnson, Issaquah, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/780,432

(22) Filed: Feb. 17, 2004

(51) Int. Cl. G06F 15/173; G06F 15/16

(52) U.S. Cl. 709/224; 709/232

(57) ABSTRACT

One disclosed system for monitoring data transferred via an FTP protocol comprises a client, a server operating as an intermediary between the client and a foreign network, an audit database, and an audit module that comprises logic for monitoring the data transferred via an FTP protocol and logic for recording at least a portion of the data transferred via an FTP protocol to the audit database.

### FIELD OF INVENTION

This invention relates in general to data auditing and, more specifically, to a system and method for auditing data transferred or received using file transfer.

### DESCRIPTION OF RELATED ART

Employers are often concerned with the type of activity that employees are conducting on company computers. For instance, many companies monitor employee computers for unauthorized communication of private company information and for access to inappropriate web content, such as pornography. Companies often audit employee email and Internet traffic as part of this monitoring. Yet, employers do not monitor every possible type of Internet or network data transfer.

Along with email, employers may use File Transfer Protocol (FTP) to transfer files. FTP is a standard Internet protocol that is the simplest way to exchange files or data between computers on the Internet. FTP is an application protocol that uses the Internet's Transmission Control Protocol/Internet Protocols (TCP/IP). FTP is commonly used to transfer Web page files to a computer that acts as a server for the Web page so that the Web page content will be available to the Internet.

FTP can be used to download and upload files from one computer to another computer. A wide variety of files may be sent using FTP, including, for example, image, audio, motion pictures, and text files, as well as executable files and computer software.

While helpful in many situations, the ability to upload and download files from a computer using FTP raises many concerns. For instance, employees and contractors are able to upload and download any type of file from their computers at work to any other computer they are connected to with the use of FTP. Thus, a disgruntled or soon to be ex-employee would be capable of uploading confidential employer information, such as trade secrets, from their computer at work to another computer away from work, such as a competitor's computer.

### BRIEF SUMMARY OF THE INVENTION

One embodiment provides a system for monitoring data transferred via an FTP protocol comprising a client, a server operating as an intermediary between the client and a foreign network, an audit database, and an audit module that comprises logic for monitoring the data transferred via FTP protocol and logic for recording at least a portion of the data transferred via FTP protocol to the audit database.

Another embodiment provides a method for transparently auditing FTP traffic comprising defining a first computer to act as an intermediary between a second computer and a third computer, defining an audit database, and defining an audit module comprising logic for monitoring data transferred via an FTP protocol.

### BRIEF DESCRIPTION OF THE DRAWINGS

FIG. 1 is a diagram representing one representative embodiment of a system operative to audit data transferred via an FTP protocol;

FIG. 2 is a flowchart illustrating steps executed to implement a system for auditing files transferred via an FTP protocol, according to an embodiment of the present invention; and

FIG. 3 depicts a block diagram of a computer system which is adapted to use an embodiment of the present invention.

### DETAILED DESCRIPTION

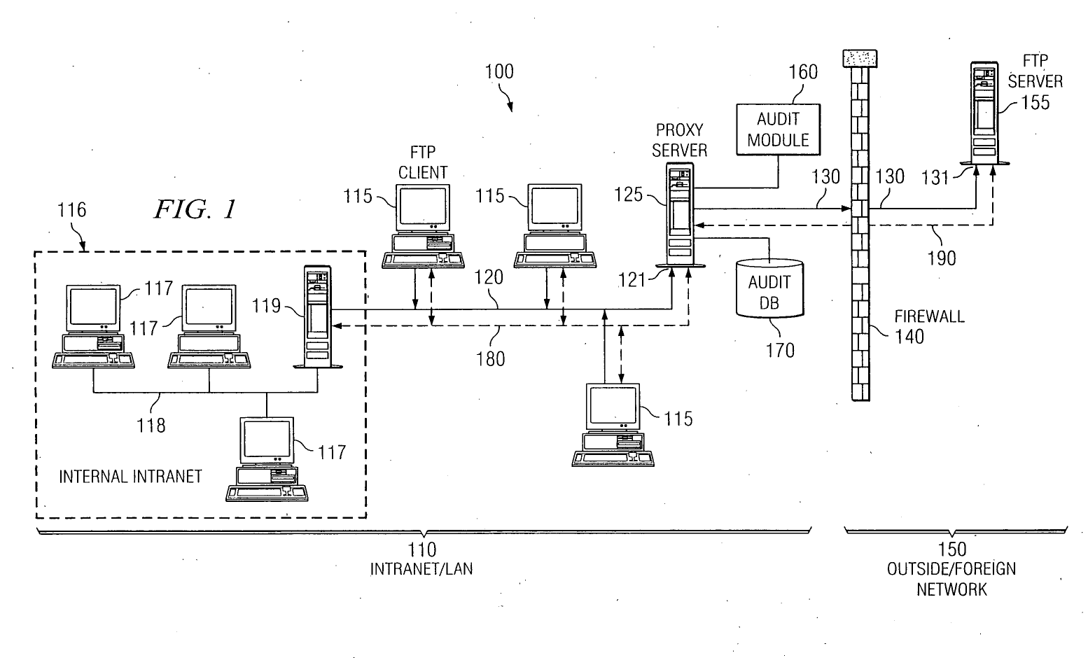

FIG. 1 is a diagram illustrating one embodiment of a system 100 operative to audit data transferred via an FTP protocol. Data auditing system 100 is used to monitor data transferred via an FTP protocol. In one embodiment, data auditing system 100 may comprise intranet 110, firewall 140, and foreign network 150. Intranet 110 may comprise an internal intranet 116, workstations 115, communication links 120 and 130, and proxy server 125. Internal intranet 116 may comprise workstations 117, communication link 118, and server 119. Foreign network 150 may represent any network that is located on the other side of firewall 140, such as the Internet.

Firewall 140 operates to protect the resources of an intranet 110, such as a private network or company intranet, from users of other networks, such as foreign network 150. For example, when an employer or company has an intranet, such as intranet 110, and allows employees to access foreign networks, such as the Internet, the employer will typically install a firewall, such as firewall 140, to protect its own private data resources. Private resources that are protected may include confidential information located within intranet 110. Firewall 140 typically operates to prevent competitors and other outsiders from accessing these private data resources, and may also be used to control the access its employees have to outside resources. In one embodiment, firewall 140 may be located on a computer separate from the rest of intranet 110 in order to insure that no incoming request can directly access private data resources.

As illustrated in FIG. 1, intranet 110 includes clients 115, communication links 120 and 130, and a proxy server 125 having an audit module 160 and an audit database 170. Intranet 110 represents a local area network (LAN) of an employer or company that is isolated from foreign network 150. For example, intranet 110 could be a group of employee workstations at a company's headquarters, or home office wherein all company employee workstations are connected to the same internal network.

In one embodiment, client 115 is a computer or workstation inside of intranet 110, such as a personal computer at an employee's desk or work terminal. However, in an alternative embodiment, client 115 may also represent an internal intranet 116 inside of a company LAN. Internal intranet 116 may comprise a plurality of clients 117 connected to one another and to a server 119 via a communication link 118. Server 119 is connected to proxy server 125 via communication link 120. For instance, client 115 could be an internal intranet 116 representing one division of a company such as the research and development team, legal department, manufacturing department, etcetera.

Communication link 120 represents a communication path between client 115 and proxy server 125. Communication link 130 represents a communication path between proxy server 125 and foreign network 150. Any mechanism for transmitting data from one location to another may be used to embody communication links 118, 120, and 130, such as a data bus, a telephone line, an ethernet cable, a wireless connection, etcetera. Communication links 120 and 130 are illustrated in FIG. 1 with outgoing arrows 121 and 131. Outgoing arrows 121 and 131 illustrate the direction of transaction initiation. Accordingly, transaction initiation occurs from client 115 inside of intranet 110 to proxy server 125 and out to FTP server 155 of foreign network 150. Transaction initiation does not occur from foreign network 150 into intranet 110. For example, when an employee at a workstation, such as client 115, wishes to access some information located external to the employer's network, such as an Internet web page in foreign network 150, the employee will initiate the transaction to reach the desired information.

FIG. 1 further illustrates data flow paths 180 and 190. Data flow paths 180 and 190 are illustrated with arrows on both ends which represents the dual direction in which data may flow. The transfer of data can flow from client 115 to proxy server 125 then to FTP server 155 of foreign network 150 or from FTP server 155 of foreign network 150 into proxy server 125 and then to client 115. The dual nature of data flow allows client 115 to send data out away from itself and to pull data in towards itself. For example, client 115 can transfer files out of intranet 110 via FTP to foreign network 150 into FTP server 155.

Proxy server 125 is a server that acts as an intermediary between a workstation, such as client 115, and some other network, such as foreign network 150, so that intranet 110 can ensure security, administrative control, and caching service. Proxy server 125 may also help to separate intranet 110 from firewall 140 to further ensure the security of intranet 110. All data traveling into or out of intranet 110 will pass by proxy server 125 which ultimately helps data auditing system 100 to track and monitor transferred data. For instance, if an employee wishes to download data, such as MPEG-1 Audio Layer-3 (MP3) audio files or bitmap (BMP) image files, from the Internet, the information will come across firewall 140 and proxy server 125 in traveling to the employee.

In a representative embodiment, proxy server 125 includes an audit module 160 and an audit database 170. As illustrated in FIG. 1, audit module 160 may be a module located within proxy server 125. However, in alternative embodiments, audit module 160 may be located in a separate computer connected to proxy server 125. Likewise, audit database 170 may be a database located in proxy server 125 or it may be a separate database that is separate from proxy server 125. Although illustrated in FIG. 1 as separate elements, data auditing system 100 may be configured so that audit module 160 and audit database 170 are located within one computer that may be separate from proxy server 125.

In one embodiment, audit module 160 is a set of computer instructions that operate to transparently monitor data transferred between client 115 and foreign network 150. Audit module 160 provides a transparent way to monitor/audit data transfers and traffic, such as FTP traffic. Thus, client 115 is unable to determine that audit module 160 is auditing and recording transferred data. In monitoring transferred data, audit module 160 will monitor data travelling from client 115 to foreign network 150, as well as data that travels from foreign network 150 to client 115. Audit module 160 may be a set of instructions in a separate program or it may be a set of instructions incorporated into an existing program already loaded onto proxy server 125. Audit module 160 may continuously run on a computer in which it is installed or it may be implemented so that it executes once, stops, and then re-executes at some interval of time. In another embodiment, audit module 160 may include one set of instructions that monitors the flow of data traffic across proxy server 125 and another set of instructions that monitors the actual content of the data that travels across proxy server 125. In an alternative embodiment, audit module 160 may monitor only the data that exits from intranet 110 travelling towards foreign network 150 while not monitoring data that flows from foreign network 150 into intranet 110. Alternatively, audit module 160 may be configured to monitor all the data that flows across proxy server 125.

In an exemplary embodiment, audit module 160 will operate to record monitored data to audit database 170. Audit module 160 may record to database 170 all data travelling from client 115 to foreign network 150 and/or it may record all data traveling from foreign network 150 to client 115. However, data auditing system 100 may be configured so that the amount of data recorded is reduced by applying some logic before deciding whether or not to record data transferred across proxy server 125. Thus, when a file is transferred from client 115 to foreign network 150 or from foreign network 150 to client 115 through an FTP transfer, audit module 160 will apply some logic to the transferred file before deciding whether or not to record the file to audit database 170.

The logic may be configured so that it searches for files that are suspicious. Suspicious files may include private company information, such as financial data, future product plans, trade secret information, etcetera. In an alternative embodiment, the logic may also search for data that includes inappropriate content, such as pornography, politically incorrect humor, terrorism activities, etcetera. Thus, whenever data is transferred from client 115 out to network 150 or from network 150 into client 115, the logic may evaluate the data to determine if the data will be recorded or not recorded. For example, if an employee at his desk is surfing the Internet and begins to download a patch for an operating system, the audit module 160 may not record that data transfer. However, if an employee were surfing the Internet and began to send or receive pornographic data or confidential information about a particular product line, audit module 160 would download that data transfer and any metadata associated with that transfer to audit database 170.

The monitoring of FTP traffic is difficult because FTP traffic is often non-ASCII and difficult to filter. In addition, files transferred through FTP can be compressed which increases the complexity of filtering the content of the files. Therefore, audit module 160 may be implemented to fully record all suspicious data transfers to audit database 170. Audit module 160 may also record metadata associated with all transferred files. Metadata is stored along with the transferred files and may include data such as which client sent the file, where was the file sent, what is the name of the file sent, what is the date of file transfer, what is the size of the file sent, etcetera. The metadata may also be correlated with other employee or personnel data to determine when inappropriate actions have occurred. For example, if an employee had recently left a job to work for a competitor, the employer could check the audit database 170 to see if the employee had recently transferred any files from the employer network, such as intranet 110, to a machine located at the competitor's company. The employer could also check the content of the transferred files to determine if the ex-employee has given away any company secrets. Thus, the employer would in effect be checking data records in audit database 170 for any files that were transferred from intranet 110 to foreign network 150.

In one embodiment, audit module 160 may operate to monitor any requests by client 115 or server 155 for data ports when monitoring data transfers. For example, when an FTP client, such as client 115, requests access to a first port, such as a control port, of a machine that is external to intranet 110, such as FTP server 155, to transfer data to the external machine, a proxy server will monitor a second port, such as a data transfer port, to determine if the second port is operating to transfer the actual file data. When a request for the second port occurs, the proxy server, such as proxy server 125, will then open a third connection to a database, such as audit database 170, and record the data being transferred. The recordation of this data will be transparent to both the client transferring data and to any computer receiving the transferred data.

Audit database 170 will be organized so that its contents can easily be accessed, managed, and updated. It may be implemented on any number of various storage devices. For example, audit database 170 may be implemented on a hardisk, for example a 40 gigabyte or 140 gigabyte disk, or mass storage may be used depending on the nature of its use. Audit database 170 may be implemented in any number of the various types of databases. For example, database 170 may be a relational database, a distributed database, an object-oriented programming database, etcetera.

Audit database 170 may also be configured so that any metadata stored with any suspicious files are arranged so that various queries may be executed on audit database. For example, metadata may be arranged in the database so that a user may easily locate a particular string of data by executing a Structured Query Language (SQL) search of the metadata. In one embodiment, the organization and structure of a table (table schema) in audit database 170 may be implemented to include the following:

| | |
|---|---|
| ftpclient | CHAR(256), |
| ftpserver | CHAR(256), |
| filename | CHAR(256), |
| date | DATE, |
| filesize | INT, |
| filedata | BLOB; |

This organization structure would provide for the storage of both file data and metadata associated with the file. The different parts of this table schema are defined as follows: ftpclient represents the identity of the client who sent or received a transferred file; ftpserver represents the location where the file was transferred to or where the file was transferred from; filename represents the name of the transferred file; date represents the date of the file transfer; filesize represents the size of the transferred file, and filedata represents the actual data that was transferred. CHAR(256) indicates that the item is a character with a value up to 256 which represents the maximum size for the computer or file name. DATE is the format for a date value, INT is an integer value to indicate the size of the file. BLOB signifies binary large object which may be a file of any size. The audit database 170 is not restricted to this type of schema, and in an alternative embodiment, database 170 may be setup by a user in any orientation that provides for the logical arrangement of both the metadata and transferred data.

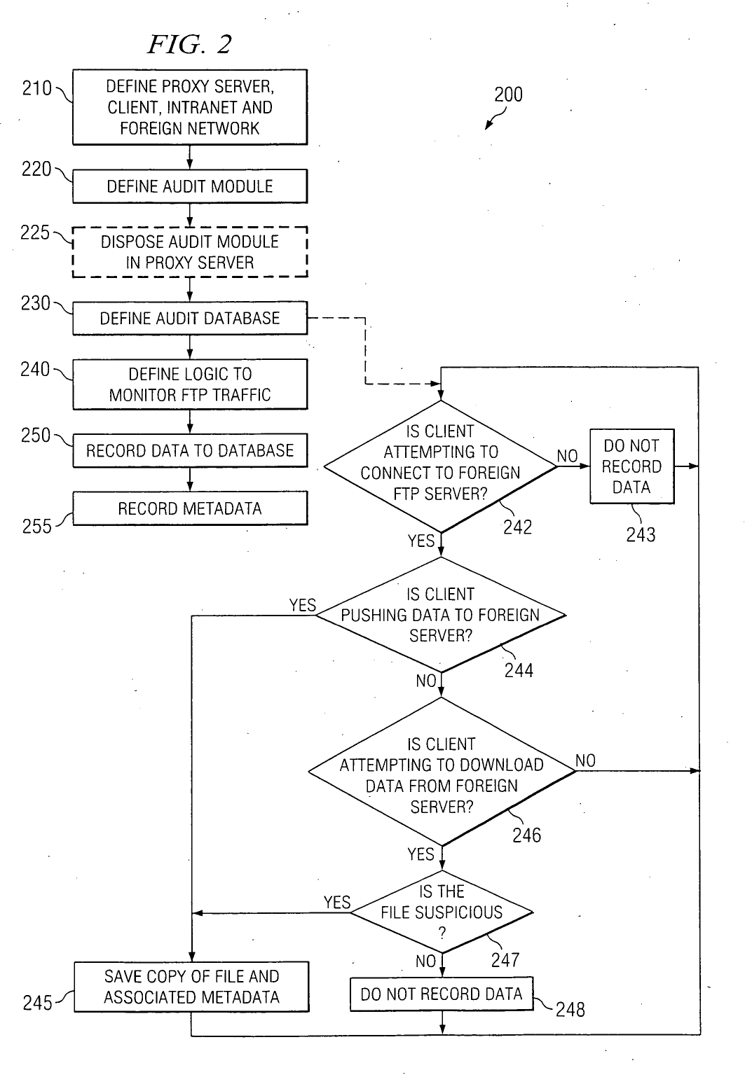

FIG. 2 illustrates a flowchart illustrating steps executed to implement a data auditing system according to an embodiment, such as the example embodiment described above. Flow 200 illustrates a method for auditing FTP traffic. In block 210, a proxy server, intranet, and foreign network are defined. In block 220, an audit module is defined, and in block 230 an audit database is defined. Optionally, the audit module may be implemented in the proxy server in block 225. After defining an audit database, logic to monitor FTP traffic is defined in block 240. The logic will typically be implemented through some type of software or computer executable code.

FTP traffic across the proxy server is monitored so that traffic travelling from the intranet to the foreign network as well as traffic travelling from the foreign network to the intranet will be monitored. After defining the logic, suspicious data will be recorded to the audit database in block 250. Flow 200 may also be arranged so that metadata associated with the suspicious data will be recorded in block 255.

Optionally, flow 200 may be arranged so that blocks 240, 250, and 255 are replaced by a set of blocks that specifically define logic that may be used in monitoring FTP traffic. This logic is presented in blocks 242-248 so that block 242 would follow block 230. In block 242, a query, as to whether a client is attempting to connect to a FTP server located outside of the intranet, would be executed. If a client is not attempting to connect to a FTP server located outside of the intranet, then the logic would proceed to block 243. In block 243, the logic will not record any data. Upon exiting block 243, the flow of the logic will return to block 242 to continue monitoring FTP traffic.

If a client is attempting to connect to a FTP server located outside of the intranet, then the logic will proceed to block 244. In block 244, a query as to whether a client is attempting to push data to an FTP server located outside of the intranet is executed. If the client is attempting to push data to a foreign FTP server, then logic proceeds to block 245. In block 245, logic will save a duplicate copy of the file and associated metadata to an audit database. Blocks 244 and 245 illustrate that any time data is sent to a foreign server, the data will be recorded regardless of the content of the file transferred to the foreign server. However, flow 200 may be configured so that a check for a suspicious file would occur after block 244 and before block 245 to determine if a suspicious file is being sent to a foreign server. A suspicious file in the context of a file being sent to a foreign server by a client may be defined to include files such as proprietary or confidential company information, any data that is deemed to be in violation of company guidelines, audio files, image files, movie files, pornographic data files, terrorist activity data, etcetera. Proprietary company information may include information such as economic forecasts, financial reports, earnings statements, personnel lists, employee telephone lists, salary data, etcetera. Confidential company information may include information such as trade secrets, research and development information, product designs, patent applications, etcetera. However, suspicious files are not restricted to these examples. If a suspicious file is being sent to a foreign server then the file would be copied to a database in step 245. However, if the file transferred to a foreign server is not suspicious, then flow 200 could operate to not record the file at all or to record only the metadata associated with the non-suspicious file.

Flow 200 may also be configured so that only the metadata associated with the file is copied or so that only the file is copied to the audit database. Alternatively, there could be multiple audit databases wherein the files that are transferred to a foreign FTP server are copied to one database and the metadata associated with the transferred file is copied to another database. After copying data to the audit database, the logic will return to block 242 to continue monitoring FTP traffic.

If the client is not attempting to push data to a foreign FTP server, then logic proceeds to block 246. In block 246, logic will execute a query to determine if the client is attempting to download a file from a foreign FTP server. If a client is not attempting to download a file from the foreign FTP server, then logic will return to block 242 to monitor FTP traffic. However, if a client is attempting to download a file from a foreign FTP server, then logic proceeds to block 247. In block 247, logic will execute a query to determine if the file is suspicious. A user of the logic can define a suspicious file as any type of file which satisfies certain criteria selected by the user. For example, a suspicious file may be defined to include files such as an audio file, image file, movie file, pornographic data file, terrorist activity data, etcetera. However, logic defining suspicious files is not restricted to these examples. In addition, a user, such as a company employee in charge of security for the company, may incorporate company guidelines that define acceptable content into the logic for determining if a file is suspicious. The acceptable content may comprise any number of various files. For example, acceptable content may be defined to be data that does not include audio files, image files, movie files, pornographic data files, terrorist activity data, etcetera. However, acceptable content is not restricted to these examples.

If the file is suspicious, then logic will proceed to block 245 and save a duplicate copy of the file and associated metadata to an audit database. However, if the file is not suspicious, then logic will proceed to block 248 and will not record the data. After block 248, the logic will then proceed to block 242 to continue monitoring FTP traffic.

Although the foregoing examples have been made with reference to the layout of elements in FIG. 1, the concepts of the present invention may be applied to any number of computer configurations. Audit module 160 may be configured to monitor data traffic in any client/server configuration where data may be transferred from one client or server to another client or server and audit module 160 may be implemented in systems where there is no firewall or foreign network. For instance, in one embodiment, audit module may monitor traffic among a plurality of clients within an intranet whether there is a foreign network or not.

When implemented in software, the elements of the embodiments are essentially the code segments to perform the necessary tasks. The program or code segments can be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etcetera. The computer data signal may include any signal that can propagate over a transmission medium such as electronic network channels, optical fibers, air, electromagnetic, RF links, etcetera. The code segments may be downloaded via computer networks such as the Internet, Intranet, etcetera.

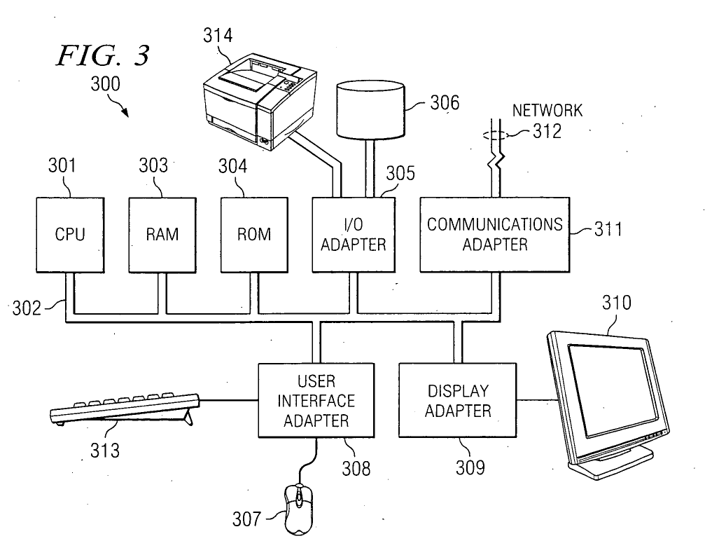

FIG. 3 illustrates computer system 300 adapted to use embodiments of the present invention, e.g. storing and/or executing software associated with the embodiments. Central processing unit (CPU) 301 is coupled to system bus 302. The CPU 301 may be any general purpose CPU, such as an HP PA-8500 or Intel Pentium processor. However, embodiments of the present invention are not restricted by the architecture of CPU 301 as long as CPU 301 supports the inventive operations as described herein. Bus 302 is coupled to random access memory (RAM) 303, which may be SRAM, DRAM, or SDRAM. ROM 304 is also coupled to bus 302, which may be PROM, EPROM, or EEPROM. RAM 303 and ROM 304 hold user and system data and programs as is well known in the art.

Bus 302 is also coupled to input/output (I/O) controller card 305, communications adapter card 311, user interface card 308, and display card 309. The I/O adapter card 305 connects storage devices 306, such as one or more of a hard drive, a CD drive, a floppy disk drive, a tape drive, to computer system 300. The I/O adapter 305 is also connected to printer 314, which would allow the system to print paper copies of information such as documents, photographs, articles, etcetera. Note that the printer may be a printer (e.g. dot matrix, laser, etcetera.), a fax machine, scanner, or a copier machine. Communications card 311 is adapted to couple the computer system 300 to a network 312, which may be one or more of a telephone network, a local (LAN) and/or a wide-area (WAN) network, an Ethernet network, and/or the Internet network. User interface card 308 couples user input devices, such as keyboard 313, pointing device 307, etcetera to the computer system 300. The display card 309 is driven by CPU 301 to control the display on display device 310.

1. A system for monitoring data transferred via an FTP protocol comprising:
a client;
a server operating as an intermediary between said client and a foreign network;
an audit database; and
an audit module comprising:
logic for monitoring said data transferred via FTP protocol; and
logic for recording at least a portion of said data transferred via FTP protocol to said audit database.

2. The system of claim 1 wherein said client is capable of receiving data from said foreign network.

3. The system of claim 2 wherein said logic for monitoring operates to monitor data that said client receives from said foreign network.

4. The system of claim 3 wherein said audit module further comprises:
logic for recording metadata associated with said data that said client receives from said foreign network and wherein said logic for recording at least a portion of data transferred via FTP protocol operates to record all data that said client receives from said foreign network.

5. The system of claim 3 wherein said logic for recording operates to record all data that said client receives from said foreign network.

6. The system of claim 3 wherein said audit module further comprises:
logic for recording metadata associated with said data that said client receives from said foreign network.

7. The system of claim 4 wherein said logic for recording all data operates to record said data only if said logic for monitoring said data transferred via FTP protocol determines that said data that said client receives from said foreign network comprises at least one of:
pornographic data;
image data;
audio data; and
terrorist activity data.

8. The system of claim 5 wherein said audit module further comprises company guidelines defining acceptable content wherein said logic for recording all data operates to record said data only if said audit module determines that said data that said client receives from said foreign network is in violation of said company guidelines.

9. The system of claim 1 wherein said client is capable of transferring data to said foreign network.

10. The system of claim 9 wherein said logic for monitoring operates to monitor data that said client transfers to said foreign network

11. The system of claim 9 wherein said logic for recording data operates to record all data that said client transfers to said foreign network.

12. The system of claim 11 wherein said audit module further comprises:
logic for recording metadata associated with said data that said client transfers to said foreign network.

13. The system of claim 10 wherein said audit module further comprises:
logic for recording metadata associated with said data that said client transfers to said foreign network and wherein said logic for recording at least a portion operates to record all data that said client transfers to said foreign network.

14. The system of claim 13 wherein said logic for recording all data that said client transfers to said foreign network operates to record said data only if said logic for monitoring said data transferred via FTP protocol determines that said data that said client transferred to said foreign network comprises at least one of:
proprietary company information;
confidential company information;
pornographic data;
image data;
audio data; and
terrorist activity data.

15. The system of claim 11 wherein said audit module further comprises company guidelines defining acceptable content wherein said logic for recording all data that said client transfers to said foreign network operates to record said data only if said audit module determines that said data that said client transferred to said foreign network is in violation of said company guidelines.

16. The system of claim 1 wherein said audit database comprises:
a table structure organized to comprise:
a field to store data related to a client who originated a transfer of said data;
a field to store data related to a destination of said transferred data;
a field to store data related to a name of said transferred data;
a field to store data related to a date that said data was transferred;
a field to store data related to a size of said transferred data; and
a field to store said transferred data.

17 The system of claim 1 wherein said client is an employee workstation connected to an employer's local area network.

18. The system of claim 2 wherein said audit module and said audit database are part of said intermediary server.

19. The system of claim 2 wherein said audit module is part of said intermediary server.

20 A method for transparently auditing FTP traffic comprising:
defining a first computer to act as an intermediary between a second computer and a third computer;
defining an audit database; and
defining an audit module comprising:
logic for monitoring data transferred via an FTP protocol.

21. The method of claim 20 further comprising:
disposing said audit module in said first computer.

22. The method of claim 20 further comprising:
recording said data transferred via an FTP protocol to said audit database.

23. The method of claim 22 further comprising:
recording metadata associated with said data transferred via an FTP protocol to said audit database.

24. The method of claim 20 wherein said logic for monitoring data transferred via an FTP protocol comprises:
monitoring an FTP control port of a computer receiving said data transferred via an FTP protocol;
monitoring an FTP data port of said computer receiving said data transferred via an FTP protocol; and
recording said data transferred via an FTP protocol to said audit database when said logic for monitoring said FTP data port determines that a request to transfer data via said FTP data port has occurred.

25. The method of claim 22 wherein said second computer is located in a intranet and said third computer is located in a network that is foreign to said intranet.

26. The method of claim 25 wherein said data transferred via an FTP protocol is recorded to said audit database upon a finding of either one of:
said second computer connecting to said third computer and said second computer sending data from said second computer to said third computer; and
said second computer connecting to said third computer and said second computer receiving data sent from said third computer to said second computer.

27. The method of claim 26 wherein said data received from said third computer will be recorded only upon a finding by said logic for monitoring data transferred via an FTP protocol that said received data comprises at least one of:
pornographic data;
image data;
audio data; and
terrorist activity data.

28. The method of claim 26 further comprising:
defining company guidelines that define acceptable content wherein said data received from said third computer will be recorded only upon a finding by said logic for monitoring data transferred via an FTP protocol that said received data is in violation of said company guidelines.

29. The method of claim 26 wherein said data sent from said second computer to said third computer will be recorded only upon a finding by said logic for monitoring data transferred via an FTP protocol that said transferred data comprises at least one of:
proprietary company information;
confidential company information;
pornographic data;
image data;
audio data; and
terrorist activity data.

30. A mechanism for auditing data transferred via FTP comprising:
a means for transparently monitoring said data transferred via FTP; and
a means for recording at least a portion of said data transferred via FTP.

31. The mechanism of claim 30 further comprising:
a means for recording metadata associated with said data transferred via FTP.

32. The mechanism of claim 31 wherein said means for recording further comprises a means for organizing said data transferred via FTP.

33. A computer program product having a computer readable medium having computer program logic recorded thereon for monitoring data transferred via an FTP protocol, the computer program product comprising:
code for transparently examining data transferred via an FTP protocol; and
code for recording at least a portion of said data transferred via an FTP protocol.

34. The computer program product of claim 33 wherein said code for transparently examining comprises:
code for determining an origination point of said data transferred via an FTP protocol; and
code for determining an end point of said data transferred via an FTP protocol.

35. The computer program product of claim 34 wherein said code for transparently examining further comprises:
code for determining a filename of said data transferred via an FTP protocol;
code for determining a date said data transferred via an FTP protocol was transferred; and
code for determining a filesize of said data transferred via an FTP protocol.

36. The computer program product of claim 34 wherein said code for recording comprises:
code for recording said data transferred via an FTP protocol; and
code for recording metadata associated with said data transferred via an FTP protocol.

37. The computer program product of claim 36 wherein said code for transparently examining data further comprises:
code for determining if said data transferred via an FTP protocol is suspicious wherein said data transferred via an FTP protocol is suspicious if said data transferred via an FTP protocol comprises at least one of:
proprietary company information;
confidential company information,
pornographic data;
image data;
audio data; and
terrorist activity data.

38. The computer program product of claim 36 wherein said code for transparently examining further comprises:
code defining company guidelines that define acceptable content; and
code for determining if said data transferred via an FTP protocol is in violation of said company guidelines.

39. The computer program product of claim 38 wherein said code for recording data transferred via an FTP protocol executes to record said data transferred via an FTP protocol only if said code for transparently examining determines that said data transferred via an FTP protocol is in violation of company guidelines.

40. The computer program product of claim 37 wherein said code for recording said data transferred via an FTP protocol will record said data transferred via an FTP protocol only if said data transferred via an FTP protocol is suspicious.
